(19) United States
(12) Patent Application Publication
(10) Pub. No.: US 2014/0286691 A1
(43) Pub. Date: Sep. 25, 2014

(54) Fuselage Structure For A Means Of Transport, Means Of Transport And Method For Producing A Fuselage Structure For A Means Of Transport

(71) Applicant: Airbus Operations GmbH, Hamburg (DE)

(72) Inventor: Wolfgang Gleine, Kakenstorf (DE)

(73) Assignee: Airbus Operations GmbH, Hamburg (DE)

(21) Appl. No.: 14/218,006

(22) Filed: Mar. 18, 2014

(30) Foreign Application Priority Data
Mar. 19, 2013 (DE) 10 2013 102 812.8

(51) Int. Cl. B64C 1/06

(52) U.S. Cl. CPC B64C 1/069
USPC 403/42; 403/288; 403/336; 29/428

(57) ABSTRACT

A fuselage structure for a means of transport includes at least two fuselage segments, in each case including an outer skin with an end edge. In a connecting region of two fuselage segments the end edges of the fuselage segments are spaced apart from each other. Connecting elements establish a mechanical connection between two fuselage segments. Conducting structure-borne sound is reduced by multiple deflection of the sound path, and thus results in a reduction in structure-borne sound-induced noise in the cabin of the means of transport.

### TECHNICAL FIELD

The invention relates to a fuselage structure for a means of transport, to a means of transport comprising a fuselage structure, and to a method for producing a fuselage structure for a means of transport.

### BACKGROUND OF THE INVENTION

Noise perceptible by passengers in a cabin of a means of transport is caused by sound sources inside and outside the cabin. In the case of aircraft, systems that are installed in the fuselage, for example hydraulic systems, an air conditioning system and vacuum systems for toilets, and outside the cabin, for example boundary layer sound and engines, significantly contribute to the sound level in the cabin. Some new drive systems, for example engines with counter-rotating propellers, may generate very high sound levels for which targeted additional measures for reducing the noise on the fuselage structure are of great importance because at that location locally-introduced sound power in the form of structure-borne sound-waves propagates along the fuselage structure, and along this sound path emits airborne sound to the cabin. This results in identical noise nuisance due to high sound levels, in particular near a sound-input location of the engines.

Presently employed measures to reduce structure-borne sound, for example in aircraft, relate to installations in a predetermined aircraft structure; these measures comprise, for example, sound-absorbing glass wool insulation packages, customized cabin wall elements and acoustically decoupled suspension elements. Sound waves emanating from external sound sources thus first impinge on the primary structure of the aircraft fuselage where they excite structural vibrations that propagate along the aircraft fuselage in the form of structure-borne sound-waves. Along the propagation path of these structure-borne sound-waves airborne sound waves are emitted into the aircraft cabin, and cabin equipment elements are excited to vibrate by way of their points of attachment to the fuselage structure, which also results in sound radiation into the cabin. High sound excitation levels, which in the case of engines with counter-rotating propellers at the surface of the aircraft fuselage may be in the magnitude of up to 150 dB, correspondingly high sound levels transmitted into the aircraft cabin result, because generally speaking the loss mechanisms occurring during structure-borne sound-transmission through the aircraft fuselage and during local transmission of airborne sound into the aircraft cabin are significantly below the required extent for a cabin sound level that corresponds to the present state of the art. Because such aircraft propulsion systems are not used in civil passenger aviation, in the state of the art no effective devices exist for reducing structure-borne-sound-induced noise in the cabin.

### BRIEF SUMMARY OF THE INVENTION

An aspect of the invention proposes a fuselage structure for a means of transport, in which fuselage structure as little structure-borne-sound-induced noise arises within the fuselage structure.

Proposed is a fuselage structure comprising at least two interconnected fuselage segments, wherein the fuselage segments in each case comprise an outer skin with at least one end edge, wherein in a connecting region between two fuselage segments the end edges of the outer skin of the relevant fuselage segments are spaced apart from each other, and wherein at least one connecting means establishes a mechanical connection of the relevant fuselage segments.

It is thus a core idea of the disclosure to stop direct structure-borne sound-conduction between two interconnected fuselage segments by way of the outer skin. Complete interruption of the outer skin in the connecting region and producing a mechanical connection by way of connecting elements arranged on the structure requires multiple redirection or deflection of structure-borne sound emanating from a fuselage segment. Overall, this results in a significant reduction in the extent of cabin noise that arises as a result of structure-borne sound. By the spacing apart of the end edges of facing fuselage segments, in particular waves of low frequencies or large wavelengths are reflected at the end edges. Sound-wave reflection results, furthermore, also from a mass discontinuity due to the mass of the connecting elements on the structure when compared to that of the outer skin.

The connecting elements should be designed and used in such a manner that the lowest possible number of connecting elements is sufficient in order to ensure a space at the end edges of the outer skin. In means of transport such as aircraft, trains, ships or boats etc. fuselage segments or body segments are lined up in axial direction. The space to be set between the fuselage segments to be connected should thus preferably occur in the axial direction. The term “axial direction” refers to a main direction of extension, and particularly preferably to the longitudinal direction parallel to the longitudinal axis of the particular fuselage segment. In the case of an aircraft the direction is, for example, the direction of the aircraft fuselage, which direction coincides with the “x” axis according to DIN 9300 that applies to aviation. If the means of transport has a fuselage structure comprising several fuselage segments or body segments that are interconnected in the lateral direction, spacing-apart in this direction is thus required.

The active total cross-sectional area, which results from the connection of two fuselage segments, of conventional connecting elements, which are for example designed as screw bolts, screw rivets or similar positive-locking or non-positive-locking connecting elements overall causes a reduction in the sound-transmission cross-section when compared to a conventional connection of the outer skin of two facing fuselage segments in a connecting region. Apart from this, due to the design according to an embodiment of the invention, multiple changes in the direction of the sound propagation path from the outer skin by way of the connecting elements also result in sound reflections. Each change in direction is always followed by coupling existing sound wave propagation forms to other forms, accompanied by a reduction in strength.

In an advantageous embodiment at least one of the fuselage segments comprises stringers that end in the region of the end edge of the outer skin so that stringers of two interconnected fuselage segments are spaced apart from each other in a longitudinal direction. Such stringers are used together with frame elements and the outer skin to produce a dimensionally-stable fuselage structure. By separating the stringers the structure-borne sound-transmission at this position may also be eliminated, which even more significantly reduces noise induced by structure-borne sound. It is not mandatory for the stringers to end so as to be flush with the end edges of the outer skin; instead, said stringers may project beyond said end edges, provided spacing to the stringers and to the outer skin of the fuselage segment to be connected may be ensured. As an alternative, it is also possible for a stringer to be interrupted within the fuselage segment before it reaches the end edge of the outer skin. Of course, it is also possible for the stringers to be arranged so as to be offset in the circumferential direction, alternating between the fuselage segments, wherein in this case for reasons of symmetrical force distribution a regular equidistant circumferential arrangement is to be preferred.

In an advantageous embodiment each fuselage segment comprises a structural connecting element that is arranged on the end edge of the outer skin and that is designed to receive the at least one connecting element for connection to a structural connecting element of another fuselage segment. Each structural connecting element should thus have a mechanical strength that is sufficient to take up all the structural loads. It should be pointed out that the structural connecting elements in a connecting region are of course also spaced apart from each other in order to prevent onward-transmission of contact-induced sound.

If the fuselage structure comprises stringers, in the relevant fuselage segments said stringers may be mechanically firmly connected to the structural connecting elements so that a precise flux of force becomes possible by way of this mechanical ending. It may thus be advantageous if the structural connecting elements comprise a strap-like flange that extends in the circumferential direction, by means of which flange the stringers are connectable. This strap-like flange may be an integral component of an annular frame, for example a frame-element-like component, which comprises a strength-optimized cross section with one or several projections.

In an advantageous embodiment the interconnected fuselage segments in a connecting region comprise differently-shaped structural connecting elements. Consequently, the latter have different resonance frequencies so that in this manner a resonance that otherwise would occur in both facing structural connecting elements may reliably be prevented.

Apart from the geometry, in an advantageous embodiment the masses of the structural connecting elements may also differ. If no pressure differentials inside and outside the fuselage segment are to be expected, for example if the particular fuselage segment is arranged outside a pressurized cabin region, in addition perforated regions are imaginable, taking into account the required structural strengths in the structural connecting elements in order to reduce transmission of airborne sound between parallel surfaces of facing structural connecting elements.

In a particularly advantageous embodiment a structural connecting element is designed as a frame element that comprises, for example, an annular shape with a cross section that is singly or multiply angled in order to provide circumferential stiffening of the fuselage structure in order to absorb radial forces. A frame element is usually a single-part or multi-part body, which radially extends on the inside of the outer skin, which body is used to take up forces acting in the radial direction, wherein frame elements are arranged on the fuselage structure at regular axial spacing. In the fuselage structure according to the invention this frame element, which serves as a structural connecting element, comprises in particular an end face situated in a region of the end edge of the outer skin of the particular fuselage segment so that the end faces of structural connecting elements of facing fuselage segments extend parallel to each other in a connecting region, thus making it possible to optimally receive connecting elements and optional components situated in between.

The structural connecting elements may comprise the same material as all the remaining parts of the fuselage structure; as an alternative to this they may, however, comprise some other adequately strong material so that each structural connecting element may fully take up the structural loads occurring during operation of the means of transport.

To bridge the space between facing end edges of fuselage segments it is advantageous to use at least one cover element that extends at least between the facing end edges. The cover element is preferably flexible and covers the gap between the end edges or completely fills said gap. The cover element may comprise a strap-like flat shape that may be made to conform to the outer skin contour so that sleeve-like encompassing of the interconnected fuselage segments results. To achieve a fluid-dynamically improved transition between the outer skin contour and the cover, the outer skin in the region of the end edge may comprise an indentation or a heel to which the cover element may conform and with a matching material thickness may produce an even outer contour. The cover element may either be mechanically firmly connectable to the outer skin, or it may be displaceable at least to one side, in order to allow compensation for movements of the fuselage structure, be it as a result of thermal effect or mechanical effect. However, opening the gap to the environment must be prevented in particular in the case of aircraft with a fuselage structure according to an embodiment of the invention so that an adequately positionally-fixed arrangement of the cover element is to be aimed for. In the choice of the material to be selected it should be taken into account that in particular in the case of aircraft greatly different temperatures are experienced during flight operation, for example with the aircraft on the ground on a hot day or during cruising at high altitude, or in takeoff and landing operations with varying fuselage deflection. For this reason it may make sense to consider elastomers.

In order to seal fuselage segments that contain a pressurized cabin, sealing elements are particularly advantageous. Accordingly, the fuselage structure further comprises at least one sealing element, preferably situated in the interior of the fuselage structure in a connecting region between two fuselage segments, for producing a fluid-proof transition between the two fuselage segments. If these comprise, for example, a radially interior delimitation, the sealing element is particularly preferably to be arranged on this radially interior delimitation. The sealing element must be designed so as guarantee a permanent seal, wherein permanent flexibility is required, in particular taking into account the expected instances of deformation of the fuselage structure. This may be achieved by bellows-like structures comprising an elastomer, or by a mixture of an elastomer, metals and/or fiber-composite materials.

Pressurized bellows constructions or tube constructions that adapt to locally continuously changing gap geometries are possible, as are slidable or deformable flat cover elements.

In order to maintain a minimum space between facing end edges of fuselage segments, the use of spacers may make sense. Such spacers may be implemented in various ways, wherein a simple form could comprise adjusting shims or washers in combination with bolt-type connecting elements. A spacer may also be implemented by a section of a connecting element, which section comprises, for example, a projection, a heel or similar that is designed to rest against an end surface of a structural connecting element or the like.

In an advantageous embodiment at least one spacer comprises a piezo element that is designed to reduce structure-borne sound-conduction by means of external excitation. The anti-phase excitation of the piezo element or causing a force against mechanical excitation may reduce the conduction of structure-borne sound.

In an advantageous embodiment the piezo element, by way of a control unit connected to it, may be used to carry out active reduction of structure-borne sound-transmission. The piezo element comprises a piezo-active material that may be excited to vibrate when a voltage is applied. Compensation takes place by the anti-phase application of contraction or extraction of the piezo-active material. Efficient control requires acquisition of the structure-borne sound-waves to be compensated, a process that may be carried out by an acceleration sensor attached to the fuselage structure. For example a structural connecting element may be equipped with an acceleration sensor. By means of the signal obtained in this manner the control unit may generate the control signals for anti-phase vibration generating on the piezo element, and may provide control by way of an optional additional amplifier. Expediently, in terms of the sound path the acceleration sensor is arranged sufficiently far from the controllable spacer so that the control unit has enough time to generate control signals and to then transmit these signals with correct timing, in other words phase-effectively in terms of sound cancelling, to the piezo element.

In a likewise advantageous embodiment the piezo element is connectable to an electrical resistor which in the case of mechanical excitation of the piezo element generates heat and counteracts the mechanical excitation of the piezo element. In this arrangement the piezo element forms a vibration damper. The electrical power arising at the piezo element during movement is converted to heat by way of a resistor connected to the piezo element.

In a furthermore advantageous embodiment at least one structural connecting element comprises at least one vibration absorber that is used as a pendulum-like oscillator to compensate for vibrations. A vibration absorber may be of an active or a passive design. While active excitation in principle functions in the same manner as in the piezo element described above, a passive vibration absorber is connected relatively “softly” to the relevant structural connecting element so that the vibrating mass of the vibration absorber follows the local, structure-borne-sound-induced, movements of the structural connecting element with some delay so that compensation takes place.

The invention also relates to a means of transport with at least one fuselage structure presented above. The means of transport may be used for transporting a sizeable number of passengers present in a cabin formed in the interior of the fuselage structure or body structure. The means of transport may be an aircraft, a rail-bound vehicle, a terrestrial vehicle or a water craft. As a result of the design according to an embodiment of the invention of the fuselage structure, a particularly advantageous reduction in structure-borne-sound-induced noise may be achieved. The aircraft may, furthermore, comprise engines with propellers, for example in each case two counter-rotating propellers.

The invention further relates to a method comprising, in particular, the arrangement of two fuselage segments relative to each other, each fuselage segment comprising an outer skin in each case with at least one end edge, in such a manner that facing end edges in a connecting region are spaced apart from each other. Preferably the resulting gap is covered by means of at least one cover element.

### BRIEF DESCRIPTION OF THE DRAWINGS

Further characteristics, advantages and application options of the present invention are disclosed in the following description of the exemplary embodiments and of the figures. All the described and/or illustrated characteristics per se and in any combination form the subject of the invention, even irrespective of their composition in the individual claims or their interrelationships. Furthermore, identical or similar components in the figures have the same reference characters.

FIG. 1 shows a diagrammatic illustration of two interconnected fuselage segments.

FIG. 2 shows a top view of a structural connecting element.

FIG. 3 shows a fuselage structure with a pressurized fuselage segment and a non-pressurized fuselage segment attached thereto.

FIG. 4 shows a fuselage structure with three consecutive pressurized fuselage segments.

FIG. 5 shows a possible rigid connection between two fuselage segments.

FIG. 6 shows a modification with a rigid connection and a vibration absorber arranged thereon.

FIG. 7 shows an elastic connection between two fuselage segments.

FIG. 8 shows a combination of a rigid connection and an elastic connection.

FIG. 9 shows a rigid connection of two fuselage segments with an additional active connecting element.

FIG. 10 shows a rigid connection of two fuselage segments, wherein the outer skin in each case is connected by way of a damping element to a structural connecting element of a fuselage segment.

FIG. 11 shows a connection between two fuselage segments that is supplemented by a sealing element for a pressurized cabin.

FIG. 12 shows a sealing element whose design differs from that of FIG. 11.

### DETAILED DESCRIPTION

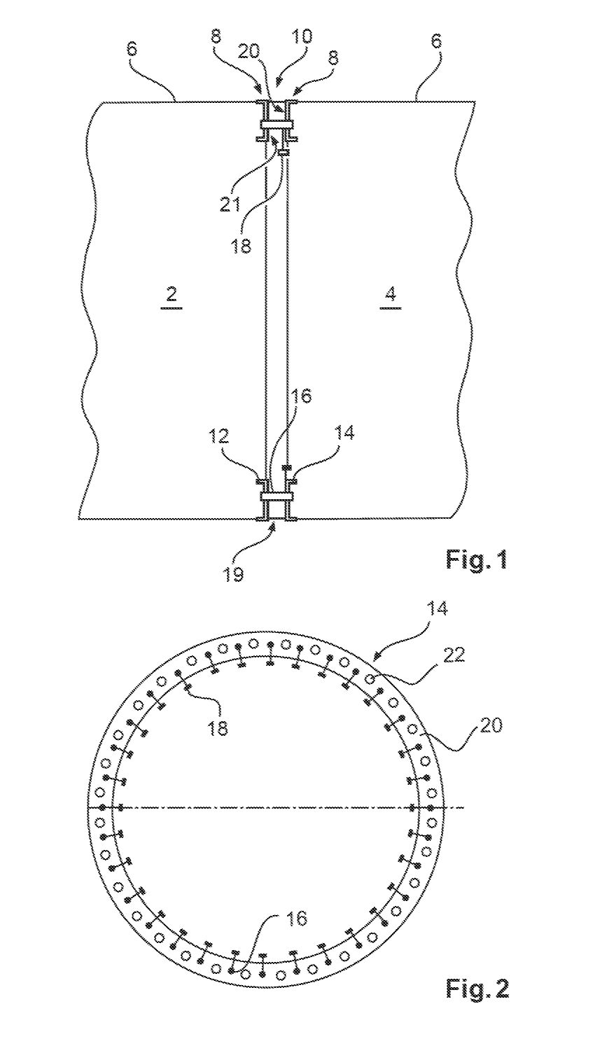

FIG. 1 shows the connection of a first fuselage segment 2 to a second fuselage segment 4, which fuselage segments in each case comprise an outer skin 6 with an end edge 8 that in a connecting region 10 face each other and are spaced apart from each other. Structure-borne sound-conduction between the first fuselage segment 2 and the second fuselage segment 4 by way of the outer skin 6 may thus be prevented. The connection takes place by way of a first structural connecting element 12 and a second structural connecting element 14, each being arranged at an axial delimitation surface of the first fuselage segment 2 or of the second fuselage segment 4. In this arrangement the structural connecting elements 12 and 14 each form a type of flange in the form of a frame element, with the aforesaid being interconnected by way of connecting elements 16. Sound conduction between the first fuselage segment 2 and the second fuselage segment 4 may thus take place only by means of deflection from the skin 6 by way of the two structural connecting elements 12 and 14 and by way of the connecting element 16 arranged in between. Because of the comparatively short joint cross section by way of the connecting elements 16 the direct sound conduction is very considerably reduced when compared to transmission by way of the skin 6. The mass discontinuity between the skin 6 and in each case the structural connecting elements 12 and 14 results in the reflection of structure-borne sound-waves, in particular of a lower frequency, which still further improves the effect.

The connecting elements 16 may be designed in the form of elongated positive-locking and/or non-positive-locking elements that allow complete transmission of structural forces and at the same time ensure spacing between the end edges 8 of the outer skin 6 of the fuselage segments 2 and 4 in the connecting region 10. For example, the connecting elements 16 are designed in the form of bolts, each comprising at least one end with a thread and a middle section that preferably has a larger diameter and serves as a spacer between the structural connecting elements 12 and 14. The middle parts of the connecting elements 16 may therefore extend between facing surfaces of the structural connecting elements 12 and 14, while the thread extends through the structural connecting elements 12 and 14 or may be reached from the side of the fuselage segment. Thus by way of the arrangement of screwing devices on the side of the fuselage segment into the connecting elements 16 reliable connection of the two fuselage segments 2 and 4 may be achieved.

Optionally (not shown in FIG. 1) the use of additional spacers or of spacers comprising a piezo element with a piezo-active material, for example in the form of washers or bushes, is possible. As an alternative or in addition, the use of vibration absorbers may suggest itself, which vibration absorbers radially extend from the structural connecting elements 12 and 14 into the interior of the fuselage, and by means of active or passive excitation of vibration may locally influence the dynamic mass or may compensate for local vibration.

The gap between the first structural connecting element 12 and the second structural connecting element 14 is covered by means of a cover element 19 in order to harmonize the external surface that is subjected to an airflow. Said cover element 19 may, in particular, comprise a flat cross section with a smooth outer contour. A number of different exemplary embodiments exist for implementing the cover element 19.

FIG. 2 shows a top view of an example of the second structural connecting element 14, wherein as an example an annular structure of a circular form has been selected. An annular surface 20 of the second structural connecting element 14 comprises a number of recesses 22 that are equidistantly distributed over the entire annular surface 20. This may serve to avoid simultaneous resonance effects of the two structural connecting elements 12 and 14 because in this arrangement the masses of the structural connecting elements 12 and 14 are different. By arranging recesses 22 that extend in the annular surface 20 that is parallel to a corresponding annular surface of the first structural connecting element 12, transmission of airborne sound may be reduced.

The connection principle according to an embodiment of the invention between two fuselage segments is suited in particular to reducing structure-borne sound of engines with propellers, and in particular with counter-rotating propellers. Such engines may be arranged at different fuselage sections directly adjacent to a passenger region or aft, and consequently different requirements in terms of the tasks to be achieved result.

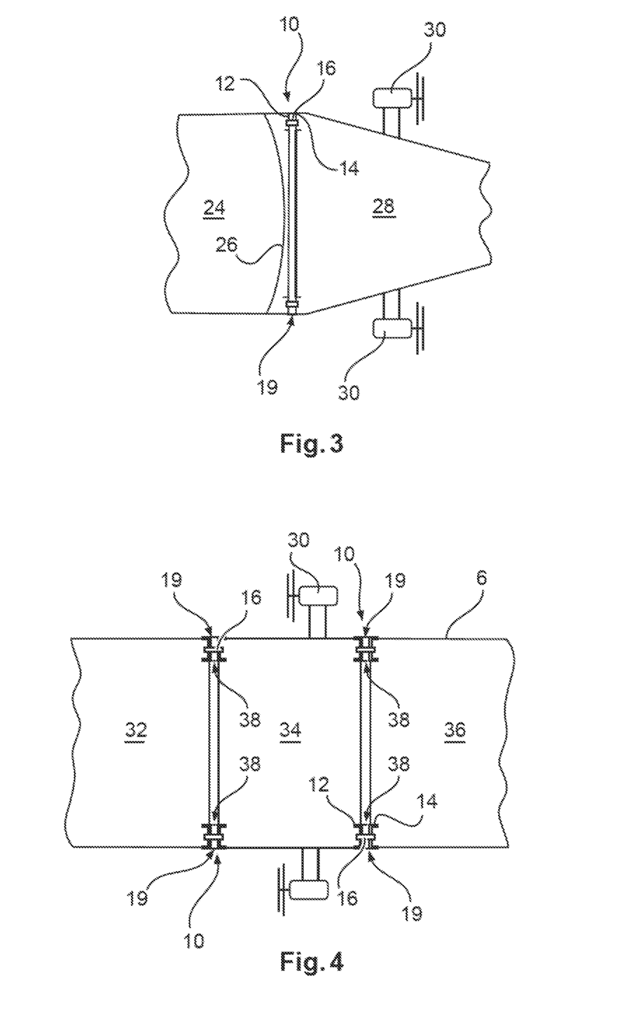

FIG. 3 shows, for example, a first fuselage segment 24 in which a pressure bulkhead 26 is arranged in order to delimit in the aft section a pressurized region of a passenger cabin. In the axial direction the pressure bulkhead 26 is followed by a first structural connecting element 12 in the form of a frame element as shown in FIG. 1. A second fuselage segment 28 is connected to the first fuselage segment 24, with two engines 30 with counter-rotating propellers being arranged on said second fuselage segment 28. This aft fuselage segment 28 comprises a second structural connecting element 14 in the form of a frame element that is connected to the first structural connecting element 12 by way of a number of connecting elements 16. The cover element 19 for bridging the gap between the two structural connecting elements 12 and 14 therefore does not have to maintain differential pressures between the fuselage and the surroundings of the aircraft because there is no differential pressure between the interior of the fuselage segments 24 and 28 in the connecting region 10 and the surroundings of the aircraft. The mechanical requirements necessary as a result of this are significantly less onerous than those shown as an example in FIG. 4.

FIG. 4 shows a first fuselage segment 32, a second fuselage segment 34 and a third fuselage segment 36 that are arranged consecutively and are interconnected according to the connecting principles according to an embodiment of the invention. Thus the first fuselage segment 32 comprises a first structural connecting element 12 in the form of a frame element, while the second fuselage segment 34 comprises a second structural connecting element 14, also designed as a frame element. These two structural connecting elements 12 and 14 are interconnected by way of connecting elements 16 and comprise a sealing element 38 which needs to maintain a pressure differential between the insides of the fuselage segments 32 and 34 and the surroundings of the aircraft. On a joint between the second fuselage segment 34 and the third fuselage segment 36 the same arrangement comprising a first structural connecting element 12 and a second structural connecting element 14 is arranged, with the aforesaid being interconnected by way of connecting elements 16. A sealing element 38 serves to harmonize the form of the outer skin in the connecting regions 10 and at the same time is designed to maintain a pressure differential between the insides of the fuselage segments 32-36 and the environment of the aircraft.

As an example, two engines 30 with counter-rotating propellers 30 are arranged on the second fuselage segment 34; in operation they transmit structure-borne sound into the second fuselage segment 34. As a result of the de-coupling connection, according to an embodiment of the invention, to the adjacent fuselage segments 32 and 36 structure-borne sound-conduction may be significantly reduced. The noise nuisance to passengers present in the adjacent fuselage segments 32 and 36 is thus significantly reduced.

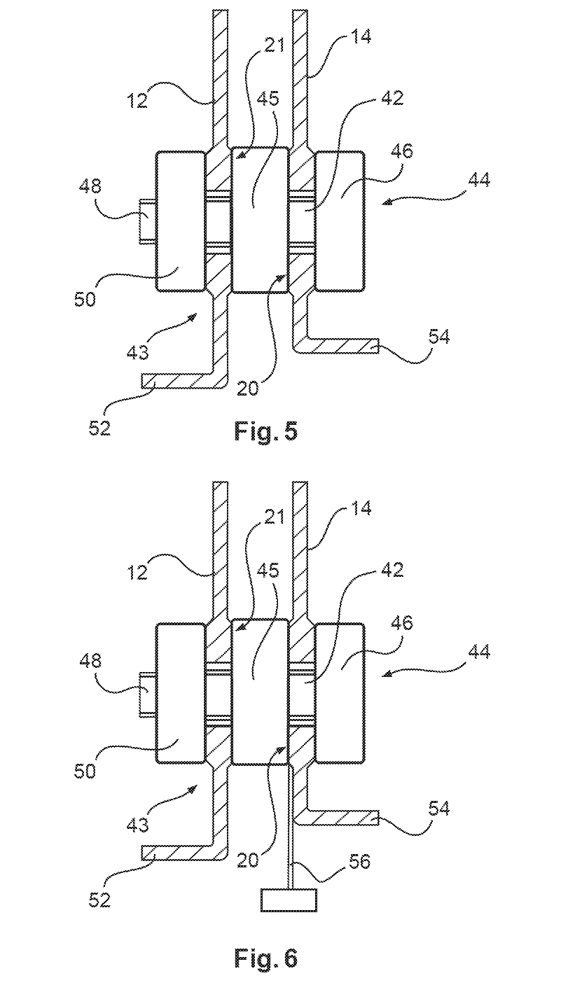

In FIG. 5 in a detail a rigid connection 43 between a first structural connecting element 12 and a second structural connecting element 14 is disclosed, with the aforesaid comprising facing delimitation surfaces 20 and 21. For connecting the two structural connecting elements 12 and 14, holes 40 and 42 are provided that are flush with each other and are designed to receive a connecting element 44, which is, for example, screwable. For example, the connecting element 44 comprises a screw head 46 and a thread 48 onto which a nut 50 may be screwed. In order to delimit the space between the two facing surfaces 20 and 21 of the structural connecting elements 12 and 14 a washer 45 is used that rests flush against the two surfaces 20 and 21. The connecting element 44 extends through both openings 40 and 42 and through the washer 45.

A certain mass discontinuity may be achieved by different radial extensions of the structural connecting elements 12 and 14, which becomes apparent from the different height of the frame element heads 52 and 54. The geometry may be optimized both in terms of structural mechanics and acoustics, a task that could also include the use of different materials. FIG. 5 shows a rigid connection wherein the material and the geometry have been optimized in terms of structural mechanics and the position of the connecting element 44 on the structural connecting elements 12 and 14.

FIG. 6 shows a similar rigid connection as shown in FIG. 5, but in addition comprises a vibration absorber 56 that is, for example, arranged on the second structural connecting element 14 and that may be excited, by way of a control unit, in such a way that the dynamically effective mass of the second structural connecting element 14 may be set. It is thus possible, despite the rigid connection, to actively counteract the transmission of structure-borne sound.

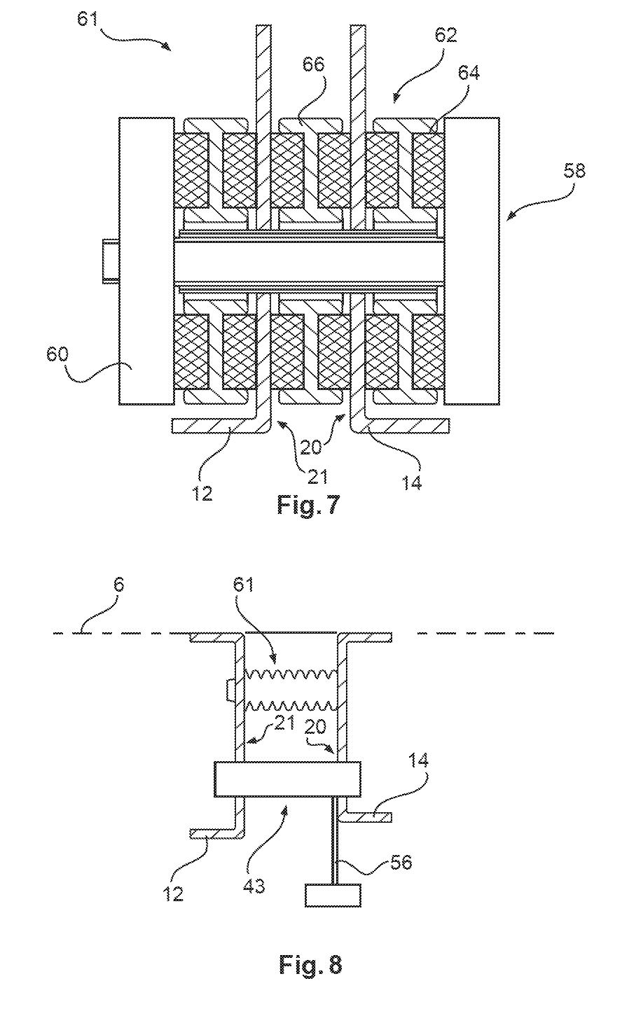

FIG. 7 discloses an elastic connection 61 in which a connecting element 58 is significantly longer when compared to the connecting element 44 of FIG. 5 so that between a nut 60 that may be screwed onto the connecting element 58 a damper arrangement 62 may extend in which the structural connecting elements 12 and 14 may be held in a positive-locking manner. The damper arrangement 62 may, for example, be implemented in the form of a multitude of elastomer discs 64 between which there are form elements 66. They serve the purpose of preventing excessive deformation of the damper arrangement 62 during abnormal force transmission, and of providing a mechanical end stop for the connecting element 58 and for the nut 60.

The connecting element 58 may also be arranged in an elastic/damping sleeve 68 in order to mechanically separate the connecting element 58 from the structural connecting elements 12 and 14. Of course, it is also possible, as shown for example in FIG. 6, to arrange a radially-inwards directed vibration absorber for example on the second structural connecting element 14.

In a further exemplary embodiment according to FIG. 8, which is shown diagrammatically, the connection principles of FIGS. 5 and 7, and possibly also 6, may be combined. Two structural connecting elements 12 and 14 thus comprise an elastic connection 61, and the active frequency range may be increased as a result of this, which results, in particular, in significantly better compensation of higher-frequency structure-borne sound.

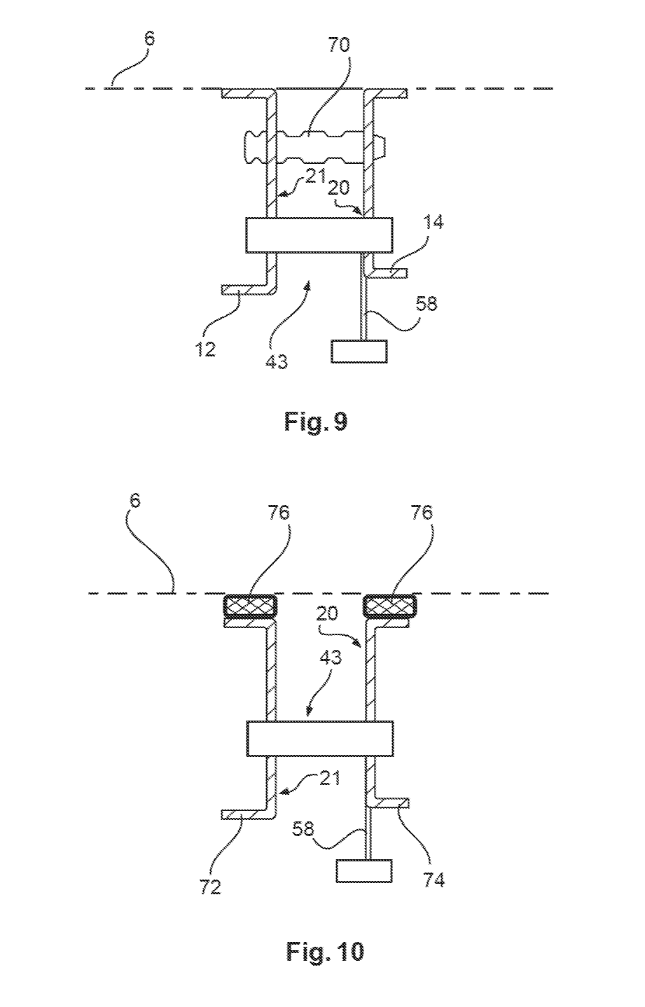

In a diagrammatic view FIG. 9 discloses the combination of a rigid connection 43 of FIG. 5 with an additional spacer 70 that comprises, for example, a piezo element. In this manner vibrations may actively be cancelled by means of anti-phase excitation of the piezo element, which results in a clear improvement of the behavior of transmitting structure-borne sound. Connecting the spacer 70 in parallel with the piezo element to the rigid connection 43 results in any failure of the piezo element having no effect on the structural strength. This may ensure the reliability of the fuselage structure.

FIG. 10 discloses, in a manner similar to that of FIG. 5, a rigid connection 43 between two structural connecting elements 72 and 74. In addition to this the two structural connecting elements 72 and 74 are in contact with the outer skin 6 only by way of a sound-absorbing elastomer material in the form of damping elements 76 so that sound conduction by way of the outer skin 6 into the structural connecting elements 72 and 74 is already significantly reduced. Reducing the sound-transmitting cross section because of the rigid connection 43 results in a further reduction in the transmitted structure-borne sound, and consequently the structure-borne-sound-induced generation of noise in the interior of the fuselage structure is very low.

FIG. 11 shows two adjacent structural connecting elements 78 and 80 that are interconnected by way of any number of connections 43, which are, for example, rigid. In addition the structural connecting elements 78 and 80 are associated with two pressurized fuselage segments, wherein it must be ensured that the pressure built up in the respective fuselage segment is not released by way of an open connection to the environment. To this effect an inner sealing element 84 is provided which, for example, extends between frame element heads 86 of the first structural connecting element 78 and 88 of the second structural connecting element 80. The sealing element 84 may comprise any desired elastically or flexibly changeable shape, which due to the radially inwards position need not conform to the smooth outer skin contour and may thus be designed exclusively for its sealing function

Apart from flat sealing elements 84 made from an elastomer, bellows constructions comprising an elastomer or a composite comprising elastomer materials and metals, fiber-composite materials and/or other plastics may be considered. The necessary characteristics of this sealing element 84 are a corresponding flexibility even at low operating temperatures, taking into account, for example, conventional flight altitudes with low temperatures at the outer skin of, for example, −30° C., adequate tensile strength, in particular in view of the expected deformation of the fuselage during takeoff and landing, a corresponding tear strength and tensile strength, resistance to alternating pressure, and of course adequate pressure tightness.

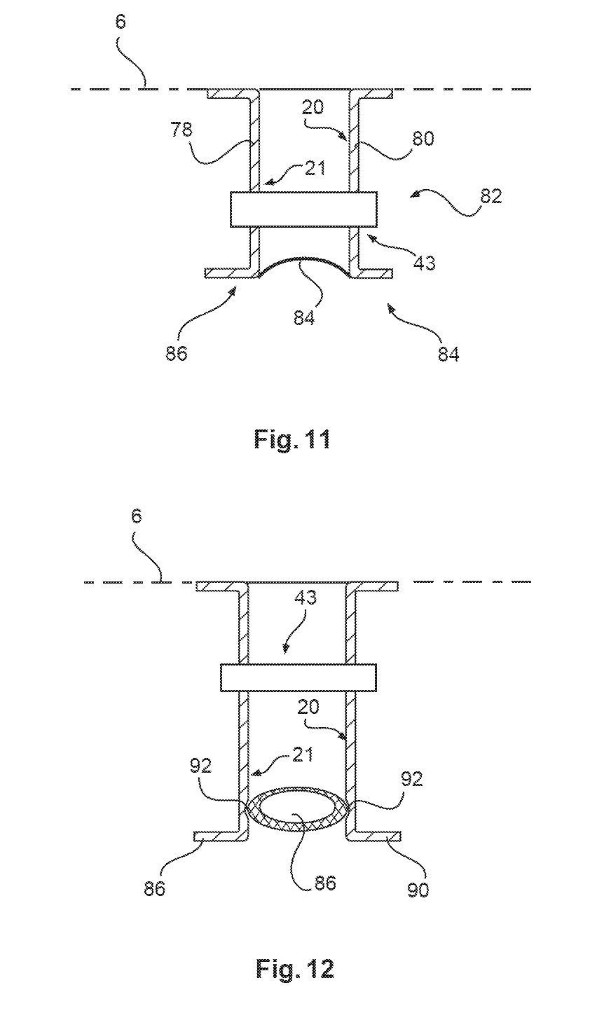

FIG. 12 shows a deviating sealing element 86, for example in the form of a hollow body that comprises a pressurized or pressurizable hollow space and that extends between facing surfaces 20 and 21 of two adjacent structural connecting elements 88 and 90 and, by way of corresponding sealing faces, provides adequate pressure tightness. To provide a particularly reliable seal the surfaces 20 and 21 may comprise recesses or indentations 92 in which the sealing element 86 is arranged and against which said sealing element 86 squeezes.

In order to improve the sealing effect, active pressurization of the sealing element 86 may be caused, be it by means of a source of compressed air, by a bleed-air line, a connection with a component of an air-conditioning system or the like. As an alternative, the sealing element 86 may be supplied at regular intervals with compressed air, by way of a valve, and may autonomously keep this compressed air.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments may also be used in combination with other characteristics or steps of other exemplary embodiments described above. Reference characters in the claims are not to be interpreted as limitations.

1. A fuselage structure for a means of transport, comprising at first and second fuselage segments, in each case comprising an outer skin with an end edge,
wherein in a connecting region of the first and second fuselage segments the end edges of the first and second fuselage segments are spaced apart from each other, and
wherein at least one connecting element establishes a mechanical connection between the first and second fuselage segments.

2. The fuselage structure of claim 1, wherein at least one of the first and second fuselage segments comprises a plurality of stringers that end in the region of the end edge of the outer skin so that the stringers of the at least one of the first and second interconnected fuselage segments are spaced apart from each other in a longitudinal direction.

3. The fuselage structure of claim 1, wherein each fuselage segment comprises at least one structural connecting element arranged on the end edge of the outer skin of the fuselage segment and is configured to receive the at least one connecting means for connection to a structural connecting element of another fuselage segment.

4. The fuselage structure of claim 3, wherein the first and second interconnected fuselage segments in a connecting region comprise differently-shaped structural connecting elements.

5. The fuselage structure of claim 3, wherein a structural connecting element is a frame element.

6. The fuselage structure of claim 1, further comprising at least one cover element extending at least between the facing end edges of the first and second interconnected fuselage segments.

7. The fuselage structure of claim 1, further comprising at least one sealing element situated in the interior of the fuselage structure in a connecting region of the first and second fuselage segments for producing a fluid-proof transition between the first and second fuselage segments.

8. The fuselage structure of claim 1, further comprising a plurality of spacers for defining a space between the interconnected fuselage segments.

9. The fuselage structure of claim 8, wherein at least one spacer comprises a piezo element configured to reduce structure-borne sound-conduction by external excitation.

10. The fuselage structure of claim 9, wherein the piezo element is connectable to a control unit, wherein the control unit is configured to excite the piezo element in such a manner that the intensity of conducting structure-borne sound is reduced by way of the at least one spacer.

11. The fuselage structure of claim 9, wherein the piezo element is connectable to an electrical resistor which in the case of mechanical excitation of the piezo element generates heat and counteracts the mechanical excitation of the piezo element.

12. The fuselage structure of claim 1, further comprising at least one vibration absorber for reducing structure-borne-sound-induced vibrations in the region of at least one end edge of an outer skin.

13. A means of transport, comprising at least one fuselage structure comprising at first and second fuselage segments, in each case comprising an outer skin with an end edge,
wherein in a connecting region of the first and second fuselage segments the end edges of the first and second fuselage segments are spaced apart from each other, and
wherein at least one connecting element establishes a mechanical connection between the first and second fuselage segments.

14. A method for producing a fuselage structure for a means of transport, comprising:
arranging first and second fuselage segments, each comprising an outer skin, relative to each other in such a manner that end edges of the outer skins are arranged so as to be spaced apart from each other, and
connecting the facing fuselage segments with at least one connecting element in such a manner that the end edges of the first and second fuselage segments are spaced apart from each other.

15. The method of claim 14, further comprising covering the gap between the end edges of the outer skin by at least one cover element.
